(19) United States
(12) Patent Application Publication
(10) Pub. No.: US 2008/0314929 A1
(43) Pub. Date: Dec. 25, 2008

(54) Dispensing Device for Single Use

(75) Inventor: Wilhelm A. Keller, Merlischachen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Mixpac AG, Rotkreuz (CH)

(21) Appl. No.: 12/086,729

(22) PCT Filed: Dec. 7, 2006
(86) PCT No.: PCT/CH2006/000687

§ 371 Date: Jun. 18, 2008

(30) Foreign Application Priority Data
Dec. 29, 2005 (CH) 2090/05

(51) Int. Cl. B67D 5/60; B67D 5/52

(52) U.S. Cl. 222/145.6; 222/137

(57) ABSTRACT

The dispensing device for single use includes a multicomponent cartridge (1), a mixer (8) having a mixer housing (9), as well as closure means for closing the outlets (4, 5) of the multicomponent cartridge. These closure means are connected to the mixer housing and comprise a respective closure stopper (13, 14) for each outlet that is insertable in an outlet (4, 5) of the multicomponent cartridge and is deformable such that upon rotation of the mixer housing relative to the cartridge, the closure stoppers (13, 14) are removed from the outlets (4, 5) of the multicomponent cartridge. Such an easily removable closure by means of deformable closure stoppers allows a very economical manufacture of dispensing devices that are intended to be used only once at it is required in medicine and in other fields.

The present invention relates to a dispensing device for single use that includes a multicomponent cartridge or syringe, a mixer having a mixer housing, as well as closure means for closing respectively opening the outlets of the multicomponent cartridge or syringe.

Currently, dispensing devices are generally reused, i.e. the content of the multicomponent cartridge or syringe is sufficient for multiple applications while the static mixer can only be used for a single application and is then replaced. In applications of multicomponent cartridges or syringes in medicine, however, the tendency is toward single use. The advantage is that a possible contamination of the patient is prevented since a single application respectively a treatment for a single patient only can thus be ensured.

Dispensing devices of the prior art, for example WO 2006/005213 A, WO 2005/021394 A, U.S. Pat. No. 5,918,772 A to the same applicant, have a cartridge with a closure that has to be removed prior to the application in order to be able to attach the mixer. Other dispensing devices comprise more or less complicated valve arrangements in order to prevent multiple use.

For single use in the medical field, such dispensing devices of the prior art are too demanding both with respect to handling as with regard to manufacture, and it is consequentially the object of the present invention to provide a dispensing device that is both economical to manufacture and simple and quick and above all safe to handle. This object is attained by a device as defined in independent claim 1. Further advantages and solutions result from the dependent claims.

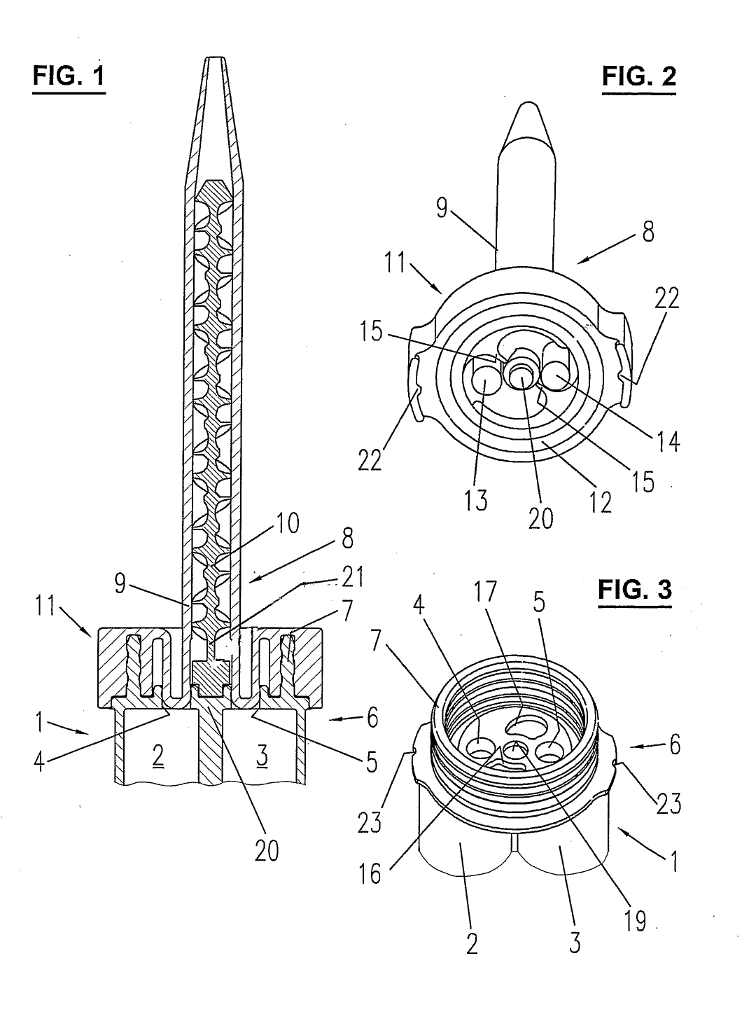

The invention will be explained in more detail hereinafter with reference to schematic drawings of an exemplary embodiment. The drawings essentially only show the interface between the mixer and the multicomponent cartridge or syringe, FIGS. 1-3 and 7 illustrating the dispensing device in the closed position and FIGS. 4-6 and 8 illustrating the dispensing device in the open position. The accessory may have one inlet or two separate inlets, but the number of closure stoppers is equal to the number of outlets on the cartridge or syringe.

FIG. 1 shows a sectional view of a mixer and of the coupling region with a double cartridge or syringe,

FIG. 2 shows a perspective view of the mixer inlet section,

FIG. 3 shows a perspective view of the outlet section of the double cartridge or syringe,

FIGS. 4-6 show the same elements as in FIGS. 1-3 in a position of the mixer housing having been rotated in the direction of the arrow (see FIG. 8),

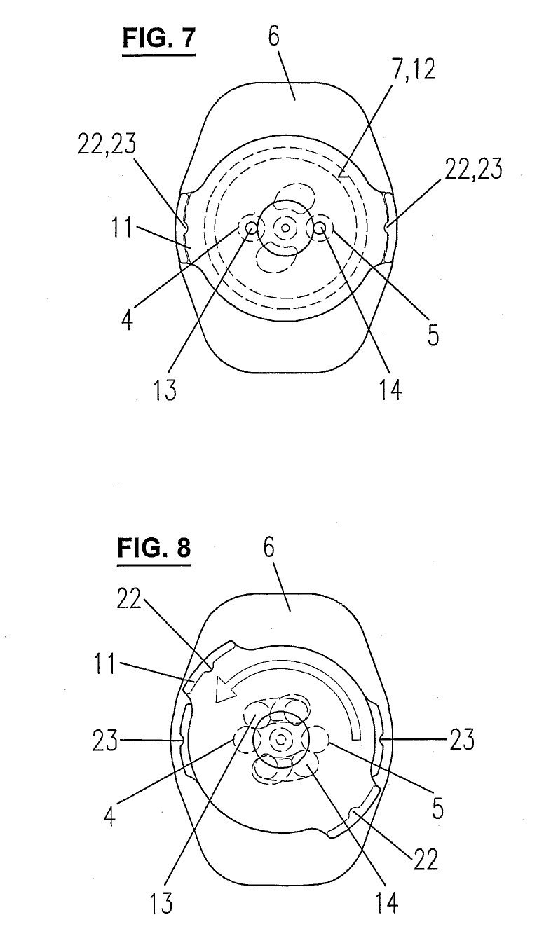

FIG. 7 shows a top view of the cartridge and of the mixer of FIG. 1,

FIG. 8 shows a top view of the cartridge and of the mixer of FIG. 4 having been rotated in the direction of the arrow.

FIG. 1 illustrates the outlet section of double cartridge 1 with the two storage containers 2 and 3, the two outlet nozzles 4 and 5 as well as outlet flange 6 provided with a circumferential, grooved snap bead 7.

Mixer 8 essentially consists of a mixer housing 9 and a mixing element 10 arranged therein. The inlet section of mixer 8 has an inlet flange 11 and an internal groove 12 receiving snap bead 7 and cooperating therewith.

According to the invention, mixer housing 9 is provided with closure stoppers 13 and 14, which are generally injection-molded integrally with the mixer housing and are insertable in outlets 2 and 3. Between closure stoppers 13 and 14, a curved separating wall 15 is arranged. Mixing element 10, seen from the inlet, has an inlet side end 20 that is followed by a separating wall 21. The purpose of both mixer housing separating wall 15 and mixing element separating wall 21 is to keep the components separated up to the first mixing segment.

In FIG. 4, two indentations 16 and 17 are depicted in outlet flange 6 which serve as an anti-reversal safety and are offset about 40°-120° with respect to the outlets. These indentations, see in particular FIG. 8, are intended to receive the ends 18 of closure stoppers 13, 14 after a rotation of the mixer housing by about 90°-180° and to prevent that the mixer housing may be turned back. For this purpose, the ends 18 of the closure stoppers may be entirely or only partly rounded or may have another shape that is suitable for providing an anti-reversal action in indentations 16 and 17. In this manner, the outlets remain free and the material can be dispensed. Furthermore, a depression 19 intended to receive end 20 on the outlet side of the mixing element is arranged in outlet flange 6.

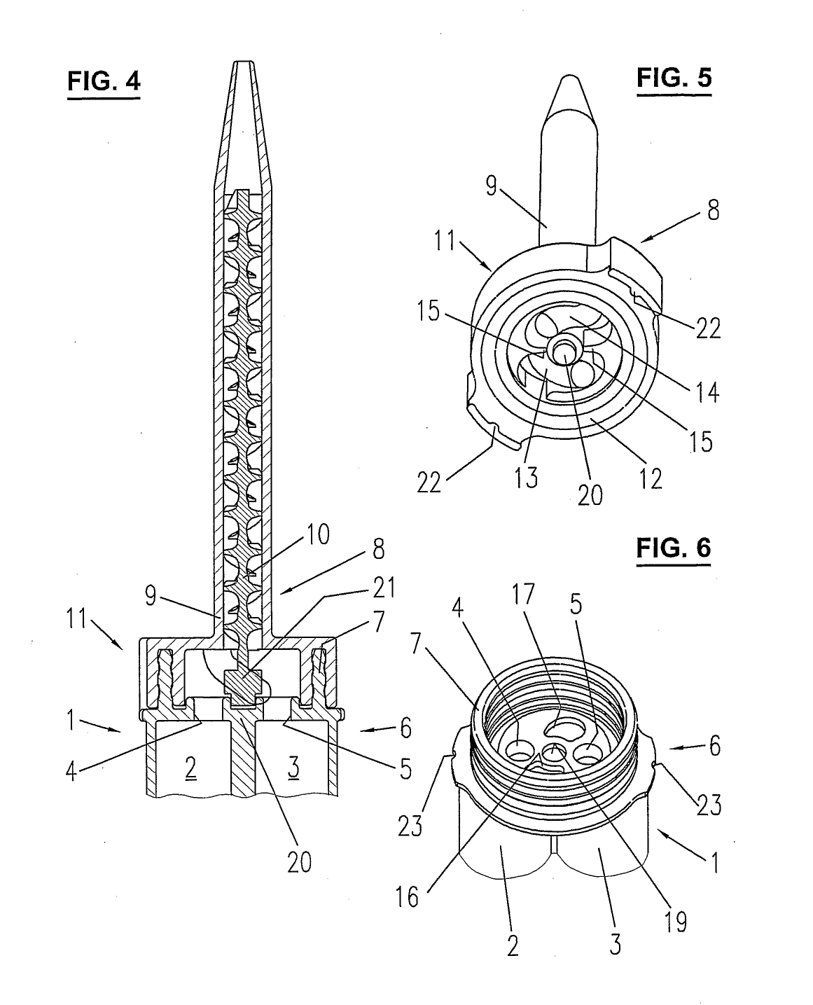

As appears especially in FIG. 5, the closure stoppers are relatively strongly bent in the open position and it is therefore evident that the latter and, if the mixer housing is integrally formed with the closure stoppers, also the mixer housing has to be produced from a material that is suitable therefor. Moreover, the closure stoppers are preferably hollow, as is clearly visible in FIGS. 1 and 4.

As already mentioned, a position of the mixer housing when rotated by about 135° with respect to FIGS. 1-3 and 7 is illustrated in FIGS. 4-6 and 8 where the closure stoppers have slipped out of the outlets and are engaged in the indentations in the outlet flange of the cartridge. As mentioned, the rotation of the mixer housing with respect to the cartridge may amount to about 90°-180°.

In FIG. 1 or 4 it is further visible that the mixer is pushed onto the cartridge and engaged at the cartridge by means of internal groove 12 at the mixer and snap bead 7 at the cartridge such that the mixer housing may still be rotated with respect to the cartridge but no longer withdrawn therefrom.

At the outlet side end, snap means in the form of noses 22 and corresponding notches 23 are suitably provided inside inlet flange 11 of the mixer and on the cartridge outlet flange such that the mixer housing is always in a defined position with respect to the cartridge and an involuntary rotation is avoided especially in the end positions. Consequently, further notches for the open position may also be provided.

A tear-off opening seal as it is known per se e.g. in medical containers may suitably be provided.

The further design of the cartridge or syringe is not depicted here as the most diverse embodiments enter into consideration for the latter and are not inventively essential. Thus, the cartridge or syringe may be directly operated manually or by means of a dispensing appliance. The same applies to the mixer, which may have an outlet or an attachment of any kind.

With respect to the exemplary embodiment, it has been said that the closure stoppers are integrally formed with the mixer housing or attachment. Although this is currently considered to be the best solution, it is also possible within the scope of the invention to provide separate closure stoppers of another material than the mixer housing or accessory, which are attachable to the mixer housing or accessory.

The invention also encompasses cartridges or syringes having more than two components, e.g. three, in which case more than two closure stoppers on the mixer housing or accessory will correspondingly result.

1. Dispensing device for single use, including a multicomponent cartridge or syringe (1), a mixer (8) having a mixer housing (9) and a mixing element (10), or an accessory, as well as closure means for closing the outlets (4, 5) of the multicomponent cartridge or syringe, whereby the closure means, which are connected to the mixer housing or accessory, comprise a closure stopper (13, 14) for each outlet that is insertable in an outlet (4, 5) of the multicomponent cartridge or syringe and is deformable such that by rotating the mixer housing or accessory relative to the multicomponent cartridge or syringe, the closure stoppers (13, 14) are removable from the outlets (4, 5) of the multicomponent cartridge or syringe.

2. Dispensing device according to claim 1, characterized in that the outlet section of the multicomponent cartridge or syringe has an anti-reversal safety means (16, 17) in order to prevent the deformed closure stoppers (13, 14) from being turned back.

3. Dispensing device according to claim 1, characterized in that a separating wall (15) is provided between the inlets of the mixer housing or accessory.

4. Dispensing device according to claim 1, characterized in that the ends (18) of the closure stoppers are entirely or partly rounded or have another shape.

5. Dispensing device according to claim 1, characterized in that the closure stoppers (13, 14) are hollow.

6. Dispensing device according to claim 1, characterized in that the separately manufactured closure stoppers (13, 14) are made from a material that is different from that of the mixer housing or accessory and are fastened thereto.

7. Dispensing device according to claim 1, characterized in that the inlet flange (I) of the rotatable mixer housing (9) or the accessory comprises snap-in means (22) cooperating with corresponding snap-in means (23) on the cartridge or syringe outlet flange (6).
